(19) United States
(12) Patent Application Publication
(10) Pub. No.: US 2015/0040075 A1
(43) Pub. Date: Feb. 5, 2015

(54) DISPLAY APPARATUS AND CONTROL METHOD THEREOF

(71) Applicant: SAMSUNG ELECTRONICS CO., LTD., Suwon-si (KR)

(72) Inventors: Won-suk CHUNG, Seoul (KR); Hong-jae KIM, Suwon-si (KR)

(73) Assignee: SAMSUNG ELECTRONICS CO., LTD., Suwon-si (KR)

(21) Appl. No.: 14/339,893

(22) Filed: Jul. 24, 2014

(30) Foreign Application Priority Data
Aug. 5, 2013 (KR) 10-2013-0092441

(51) Int. Cl. G06F 3/0488

(52) U.S. Cl. CPC G06F 3/0488
USPC 715/863

(57) ABSTRACT

Disclosed are a display apparatus that includes: an image receiving section which receives an image; an image processing section which processes the received image; a display section which displays the processed image and comprises a touch panel through which a touch input of a user is receivable; a UI generating section which generates a UI in the display section; a controller which performs a control for displaying the processed image and generating the UI including a thumbnail image corresponding to the displayed image, and determines, if the touch input of the user is received or detected at a first position of the thumbnail image of the generated UI through the touch panel, that the touch input is received or detected at a corresponding second position of the image displayed in the display section to control the image processing section.

### CROSS-REFERENCE TO RELATED APPLICATION

This application claims priority from Korean Patent Application No. 10-2013-0092441, filed on Aug. 5, 2013 in the Korean Intellectual Property Office, the disclosure of which is incorporated herein by reference.

### BACKGROUND

1. Field

Apparatuses and methods consistent with the exemplary embodiments discussed herein relate to a display apparatus and a control method thereof, and more particularly, to a display apparatus which generates a user interface (UI) including a thumbnail image corresponding to an image displayed in a display section of a display and determines, if a touch input of a user is received at a first position of the thumbnail image of the generated UI, whether the touch input is received at a corresponding second position of the image displayed in the display section to operate the entire screen of the display section, and a control method thereof.

2. Description of the Related Art

Recently, an electronic whiteboard including a display panel has been used. In a large touch-screen display apparatus such as an electronic whiteboard, it is necessary to operate a large object of the display apparatus using a touch input of a user or an electronic pointing device, or to perform an input operation using a large motion of the user. Further, in a case where the large display apparatus is formed by a plurality of display apparatuses, for example, four or nine display apparatuses, it is difficult and inconvenient to perform an operation such as selection, movement or revision of an object located at display corners, and to perform a user input.

In particular, even in a case where the large display apparatus is configured by a single display apparatus, it is difficult for a small user, such as a child, to use or access the display apparatus.

In addition, in a case where a user takes notes in a display section of the display apparatus for explanation, for example, it is difficult or impossible to effectively use a corner space of the display section, that is, the entire space of the display section, which reduces the utility of the display section.

### SUMMARY

One or more exemplary embodiments may provide a display apparatus which generates a UI including a thumbnail image corresponding to an image displayed in a display section and determines, if a touch input of a user is received at a first position of the thumbnail image of the generated UI, whether the touch input is received at a corresponding second position of the image displayed in the display section to operate the entire screen of the display section, and a control method thereof.

The foregoing and/or other aspects may be achieved by providing a display apparatus including: an image receiving section which receives an image; an image processing section which processes the received image; a display section having a display which displays the processed image and comprises a touch panel through which a touch input of a user is receivable; a UI generating section which generates a UI in the display section or on the display; a controller which performs a control for displaying the processed image and generating the UI including a thumbnail image corresponding to the displayed image, and determines, if the touch input of the user is received at a first position of the thumbnail image of the generated UI through the touch panel, whether the touch input is received at a corresponding second position of the image displayed in the display section to control the image processing section.

The controller may control the size of the UI.

The controller may control the transparency of the UI.

The controller may perform a control for at least one of generation and deletion of the UI in response to a predetermined touch input of the user.

In a case where at least one UI is generated in the display section, if the predetermined touch input is received, the controller may perform a control for moving at least one UI to a position corresponding to the predetermined touch input.

In a case where a first UI is generated in the display section, if the predetermined touch input is received, the controller may perform a control for deleting the first UI and generating a second UI at a position corresponding to the predetermined touch input.

If the touch input of the user is received at a predetermined position of the thumbnail image, the controller may control the image processing section to move the UI.

If the touch input of the user is moved while being maintained, the controller may perform a control for moving the UI corresponding to a position of the touch input.

If the touch input of the user is finished, the controller may perform a control for stopping the movement of the UI.

If the touch input of the user is finished during the movement of the UI, the controller may perform a control for moving the UI on the basis of a moving speed of the UI.

The foregoing and/or other aspects may be achieved by providing a control method of a display apparatus including: processing and displaying an image; generating a UI including a thumbnail image corresponding to the displayed image; receiving a touch input of a user at a first position of the thumbnail image of the generated UI; and determining that the touch input is received at a corresponding second position of the displayed image.

The reception of the touch input may include controlling the size of the UI.

The reception of the touch input may include controlling the transparency of the UI.

The generation of the UI may include performing at least one of generation and deletion of the UI in response to a predetermined touch input of the user.

The performance of at least one of the generation and deletion of the UI may include: receiving the predetermined touch input in a case where at least one UI is generated in the display section; and moving at least one UI to a position corresponding to the predetermined touch input.

The movement of the UI to the position of the predetermined touch input may include: deleting, if the predetermined touch input is received in a case where a first UI is generated in the display section, the first UI; and generating a second UI at a position corresponding to the predetermined touch input.

The reception of the touch input of the user may include moving, if the touch input of the user is received at a predetermined position of the thumbnail image, the UI.

The reception of the touch input of the user may include moving, if the touch input of the user is moved while being maintained, the UI corresponding to a position of the touch input.

The movement of the UI may include stopping, if the touch input of the user is finished, the movement of the UI.

The movement of the UI may include moving, if the touch input of the user is finished during the movement of the UI, the UI on the basis of a moving speed of the UI.

The foregoing and/or other aspects may be achieved by providing a display apparatus including: a display which displays an image and comprises a touch screen via which a touch input of a user is detected; and a processor receiving the image, generating a user interface (UI) on the display comprising a reduced size image of the entire image, determining, after the touch input of the user is detected at a first position of the thumbnail image of the generated UI via the touch panel, whether the touch input is detected at a second position of the image displayed on the display to control the image processing and performing an image operation when the touch input at the second position is detected.

The image operation may determine one of a size of the UI, a transparency of the UI, whether the UI is deleted, a motion of the UI, a drag of the UI, a flick of the UI and generation of a second UI.

According to the exemplary embodiments, by generating the UI of the thumbnail image corresponding to the image displayed in the display section and by operating the UI of the thumbnail image to operate the image displayed in the display section, it is possible for any user to easily operate the display section.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram illustrating a configuration of a display apparatus according to an exemplary embodiment.

FIG. 2 is a block diagram illustrating a configuration of a display apparatus according to an exemplary embodiment.

FIG. 3 is a control flowchart illustrating an operation of a display apparatus according to an exemplary embodiment.

FIG. 4 is a control flowchart illustrating an operation of a display apparatus according to an exemplary embodiment.

FIG. 5 illustrates an example in which a UI is generated by a predetermined touch input of a user in a display section of a display apparatus according to an exemplary embodiment.

FIG. 6 illustrates an example in which the size of a UI is enlarged or reduced in a display apparatus according to an exemplary embodiment.

FIG. 7 illustrates an example in which the transparency of a UI is controlled in a display apparatus according to an exemplary embodiment.

FIGS. 8 to 10 illustrate an example in which a UI is moved and generated in a display apparatus according to an exemplary embodiment.

### DETAILED DESCRIPTION OF EXEMPLARY EMBODIMENTS

Below, exemplary embodiments will be described in detail with reference to accompanying drawings so as to be easily realized and understood by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

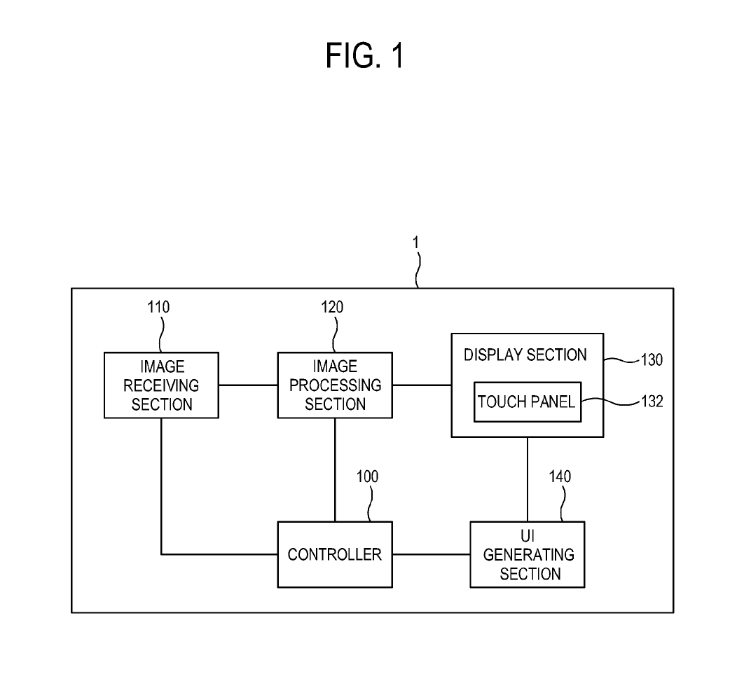

FIG. 1 is a block diagram illustrating a configuration of a display apparatus according to an exemplary embodiment, which may be a processor or computer and a display with touch sensitive capability. A display apparatus 1 according to the present embodiment may include an image receiving section or receiver 110, an image processing section 120, a display section or display 130 provided with a touch panel 132, a UI generating section or generator 140, and a controller 100. The display apparatus 1 may be realized as a large display apparatus, a multi or multi-screen display apparatus, a user terminal or the like.

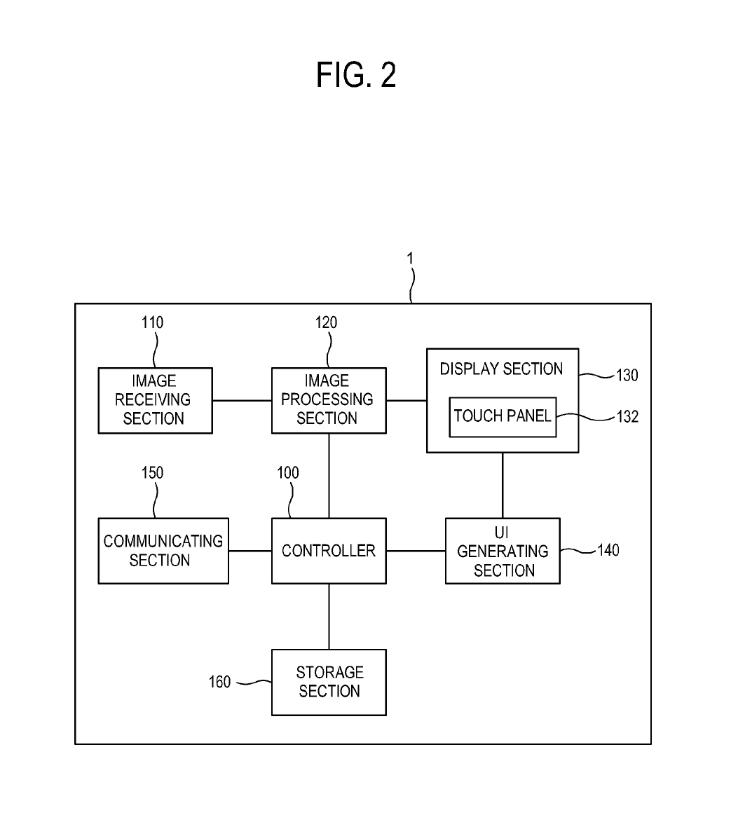

The image receiving section 110 may receive an image signal or image data in a wired or wireless manner, and may transmit the image signal or image data to the image processing section 120. The image receiving section 110 may receive, as an image signal, a broadcast signal, such as a television broadcast signal from a broadcast signal transmitter (not shown), may receive an image signal from a device, such as a digital versatile disc (DVD) player or a Blu-ray disc (BD) player, may receive an image signal from a personal computer, may receive an image signal from a mobile device, such as a smart phone or a smart pad, may receive an image signal through a network, such as the Internet, or may receive, as an image signal, image content stored in a storage medium, such as a universal serial bus (USB) storage medium. Alternatively, an image signal may not be received through the image receiving section 110, but may be stored in a storage section or storage 160 (refer to FIG. 2) to be supplied therefrom. The image receiving section 110 may be provided as various types according to the standard of the received image signal and the type of the display apparatus 1. For example, the image receiving section 110 may receive a radio frequency (RF) signal, or may receive an image signal based on the standard of composite video, component video, super video, SCART (radio and television receiver manufacturer's association), high definition multimedia interface (HDMI), DisplayPort, unified display interface (UDI), WirelessHD, or the like. In a case where the image signal is a broadcast signal, the image receiving section 110 may include a tuner which tunes to the broadcast signal according to channels.

The type of image processing performed by the image processing section 120 is not particularly limited, and may include decoding corresponding to an image format of image data, de-interlacing for converting interlaced image data to progressive data, scaling for adjusting image data into a predetermined resolution, noise reduction for improvement of image quality, detail enhancement, frame refresh rate conversion, or the like, for example.

The image processing section 120 may be realized as an image processing board (not shown) in which a system-on-chip (SOC) with integrated functions for various processes or individual chipsets for various processes are mounted on a printed circuit board, and may be built in the display apparatus 1.

The image processing section 120 may perform various predetermined image processing processes for a broadcast signal including an image signal received through the image receiving section 110 or a source image including an image signal supplied from an image supply source (not shown). The image processing section 120 may output the image signal passed through these processes to the display section 130 to display an image in the display section 130.

The display section 130 may display an image on the basis of the image signal output from the image processing section 120. The type of the display section or display 130 is not particularly limited, and may by realized as various types of displays which use liquid crystal, plasma, light-emitting diodes, organic light-emitting diodes, a surface-conduction electron-emitter, carbon nano-tubes, nano-crystal or the like.

The display section 130 may include an additional configuration according to its display type. For example, in a case where the display section 130 is a liquid crystal type, the display section 130 may include a liquid crystal panel (not shown), a backlight unit (not shown) which supplies light to the liquid crystal panel, and a panel drive board (not shown) which drives the panel.

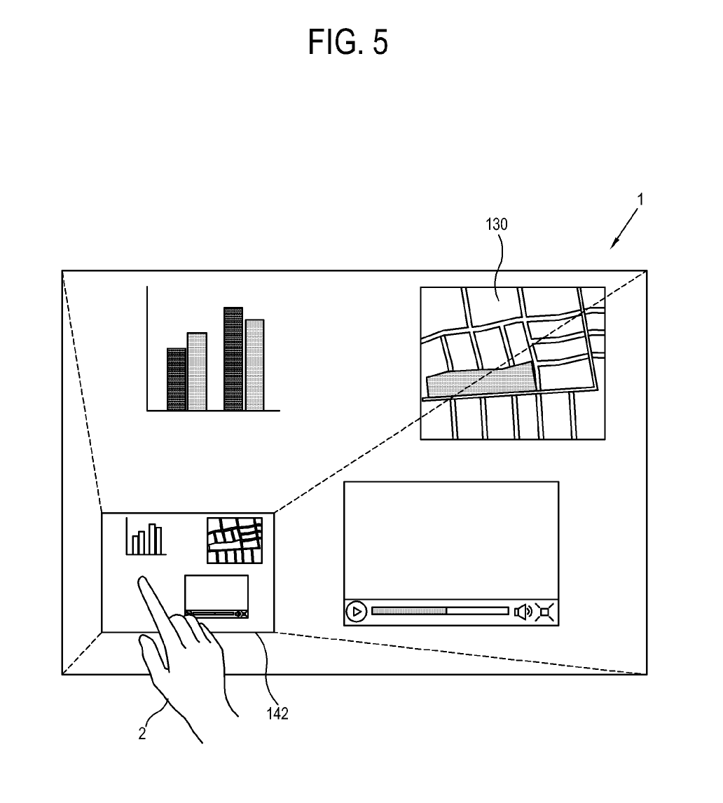

The UI generating section 140 may generate a UI 142 for operation of an application program to be executed. The generated UI 142 may include a plurality of sub-UIs provided in the form of icons, texts or the like. If a user 2 (see FIG. 5) selects a specific sub-UI through the display apparatus 1, an application program corresponding to the selected sub-UI may be operated or executed. That is, each sub-UI may be generated in the unit of a plurality of functions or events capable of operating an application program executed in the display apparatus 1.

The UI generating section 140 refers to software or hardware functions for generating and controlling the UI 142 displayed in the display section 130. The UI generating section 140 may not only be configured or realized as a separate chipset or microprocessor, but may also be executed by the controller 100 to be described later.

The controller 100 may perform a control for displaying an image in the display section 130 and generating the UI 142 including reduced size or smaller copy of the entire image, such as a thumbnail type image corresponding to the displayed image, and may determine, if a touch input of the user 2 is received at a first position of the thumbnail image of the generated UI 142 through the touch panel 132, that or whether the touch input is received at a corresponding second position of the image displayed in the display section 130 to control the image processing section 120.

FIG. 2 is a block diagram illustrating a configuration of a display apparatus according to an exemplary embodiment. As shown in FIG. 2, a display apparatus 1 according to the present embodiment includes the components shown in FIG. 1, and may further include a communicating section 150 and a storage section 160.

The communicating section 150 may receive an externally input signal, and may transmit the signal to the image processing section 120 or the controller 100. The communicating section 150 may receive a signal from an external device in a wired manner through various cables connected thereto, or in a wireless manner according to a predetermined wireless communication standard.

The communicating section 150 may include a plurality of connectors (not shown) to which the cables are respectively connected. The communicating section 150 may receive a broadcast signal, an image signal, a data signal or the like based on the standard of HDMI, USB, component video or the like, for example, from an external device, or may receive communication data through a communication network.

The communicating section 150 may further include an additional configuration, such as a wireless communication module (not shown) or a tuner (not shown) for broadcast signal tuning, according to design of the display apparatus 1, in addition to the configuration for receiving the signal or data from the external device.

The communicating section 150 may not only receive the signal from the external device, but may also transmit a signal, data or information of the display apparatus 1 to the external device. That is, the communicating section 150 is not limited to the configuration for receiving the signal or data from the external device, and may be realized as an interface which allows bi-directional communication. The communicating section 150 may receive a control signal for selection of the UI 142 from a plurality of control devices. The communicating section 150 may be configured by or as a communication module for near field communication, such as Bluetooth, infrared (IR), ultra-wideband (UWB) or Zigbee, or may be configured by or as a known communication port for wired communication. The communicating section 150 may perform various functions, such as display operation command or data transmission and reception, in addition to reception of the control signal for selection of the UI.

The storage section 160 is preferably provided as a writable non-volatile memory so that data can remain therein even though electric power is cut off and content changed by the user 2 can be reflected. That is, the storage section 160 may be provided as any one of a flash memory, an erasable programmable read-only memory (EPROM), and an electrically erasable programmable read-only memory (EEPROM). The storage section 160 may store data received from an external device, and may store various control signals to provide the signals to the controller 100. The storage section 160 may store an execution command for generation and deletion of the UI 142 in response to a touch input of the user 2.

The controller 100 may control the image processing section 120 and the display section 130 to enlarge or reduce the size of the generated UI 142.

The controller 100 may control the transparency of the UI 142. For example, the controller 100 may control the transparency of the UI 142 to be light, to thereby reduce inconvenience due to the UI 142 to a viewer who views the display apparatus 1.

The controller 100 may execute any one of generation and deletion of the UI 142 in response to a predetermined touch input of the user 2. For example, the controller 100 may generate and delete the UI 142 in response to a two-finger touch of the user 2.

If a predetermined touch input is received in a state where at least one UI 142 is generated in the display section 130, the controller 100 may move at least one UI 142 to a predetermined touch input position. For example, if the user 2 moves to the right side during use of the display in a state where the UI 142 is displayed on a lower left side of the display section 130, the user 2 may move the UI 142 to a predetermined touch input position using a long touch or drag or a three-finger touch, for example. That is, it is not necessary that the user 2 move to the left side to operate the UI 142 located on the lower left side of the display section 130.

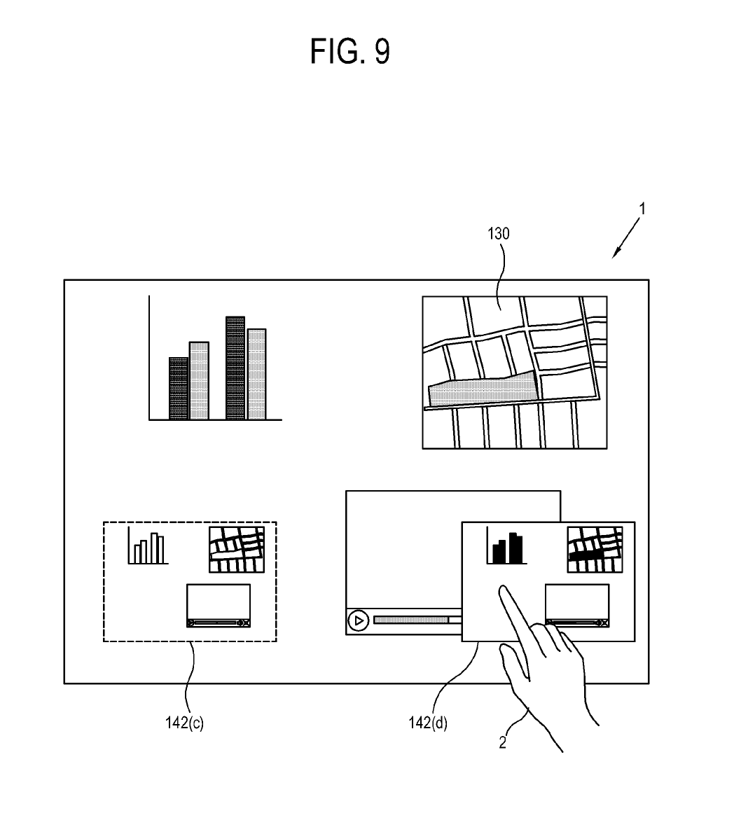

For example, as shown in FIG. 9, if a predetermined touch input is received in a state where a first UI 142(c) is generated in the display section 130, the controller 100 may delete the first UI 142(c) and may generate a second UI 142(d) at a predetermined touch input position. For example, in this case, if a two-finger long touch or drag or a two-finger double touch is input as the predetermined touch input, the first UI 142(c) on the lower left side may be deleted, and the second UI 142(d) may be generated at the predetermined touch input position. The generated second UI 142(d) may be the same as the deleted first UI 142(c).

If a touch input of the user 2 is received at a predetermined position of a thumbnail image, the controller 100 may control the image processing section 120 to move the UI 142.

If the touch input of the user 2 is moved while being maintained (a drag), the controller 100 may move the UI 142 corresponding to a position of the touch input. If the user 2 moves while touching a specific position of the UI 142, the UI 142 may move according to a position of the touch input.

If the touch input of the user 2 is finished, the controller 100 may stop the movement of the UI 142. If the touch input of the user 2 is finished during the touch movement, the controller 100 may stop the movement at a position where the touch input is finished.

If the touch input is finished during the movement of the UI 142, the controller 100 may stop the UI 142 on the basis of a moving speed (a flick) of the UI 142. If the touch input of the user 2 is finished during the movement of the UI 142, the controller 100 may move the UI 142 in a moving direction of the motion before the touch is finished according to the moving speed of the UI 142. The UI 142 may continuously move to deviate from or leave the display 130, or may stop the movement when one side edge of the display section 130 and one side edge of the UI 142 overlap with each other so as not to deviate from the display section 130.

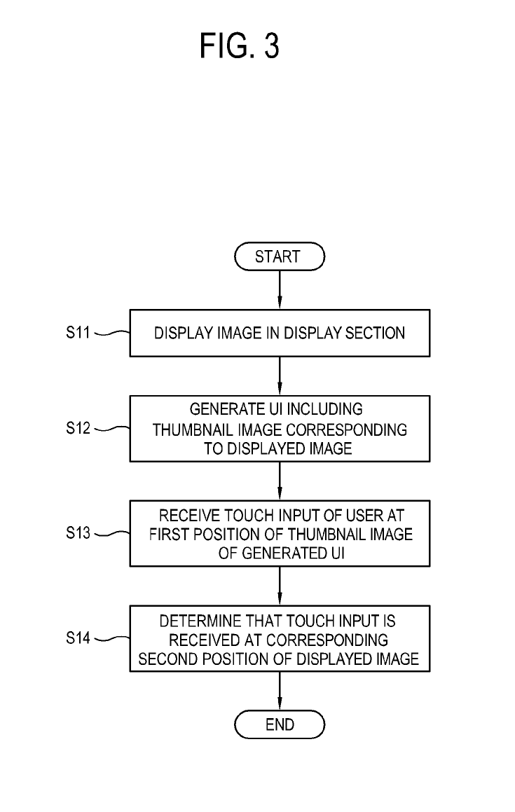

FIG. 3 is a control flowchart illustrating an operation of a display apparatus according to an exemplary embodiment.

First, an image is displayed in the display section or on the display 130 by the user 2 (S11).

Then, the user 2 performs a touch input to generate the UI 142 including a thumbnail image corresponding to the displayed image (S12).

Then, the user 2 performs a touch input at a first position of the thumbnail image of the generated UI 142, and the touch input is detected or received (S13).

Then, the controller 100 determines that the touch input is detected or received at a corresponding second position of the displayed image, and executes a command according to the touch input at the second position (S14).

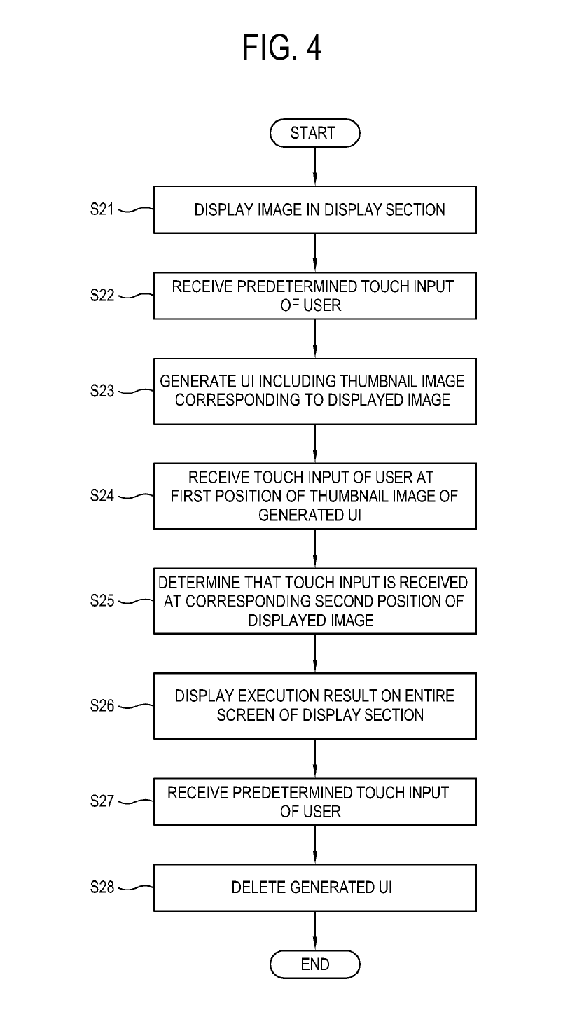

FIG. 4 is a control flowchart illustrating an operation of a display apparatus according to an exemplary embodiment.

First, an image is displayed in the display section 130 by the user 2 (S21).

Then, a predetermined touch input of the user 2 is detected or received (S22).

Then, the UI 142 including a thumbnail image corresponding to the displayed image is generated (S23).

Then, a touch input of the user 2 is received or detected at a first position of the thumbnail image of the generated UI 142 (S24).

Then, the controller 100 determines whether the touch input is received or detected at a corresponding second position of the displayed image (S25).

Then, the controller 100 executes a command according to the touch input at the second position, and displays the result on the entire screen of the display section 130 (S26).

Then, a predetermined touch input of the user 2 is received (S27).

Then, the generated UI 142 is deleted (S28).

FIG. 5 illustrates an example in which a UI is generated by a predetermined touch input of a user in a display section of a display apparatus according to an exemplary embodiment.

If a predetermined touch input of the user 2, for example, a two-finger touch is received, the UI 142 including a thumbnail image corresponding to the entire screen of the display section 130 may be generated at a position of the touch input of the display section 130, as shown in FIG. 5. The user 2 may operate the UI 142 like performing a touch input on the entire screen of the display section 130, to thereby operate the entire screen of the display section 130.

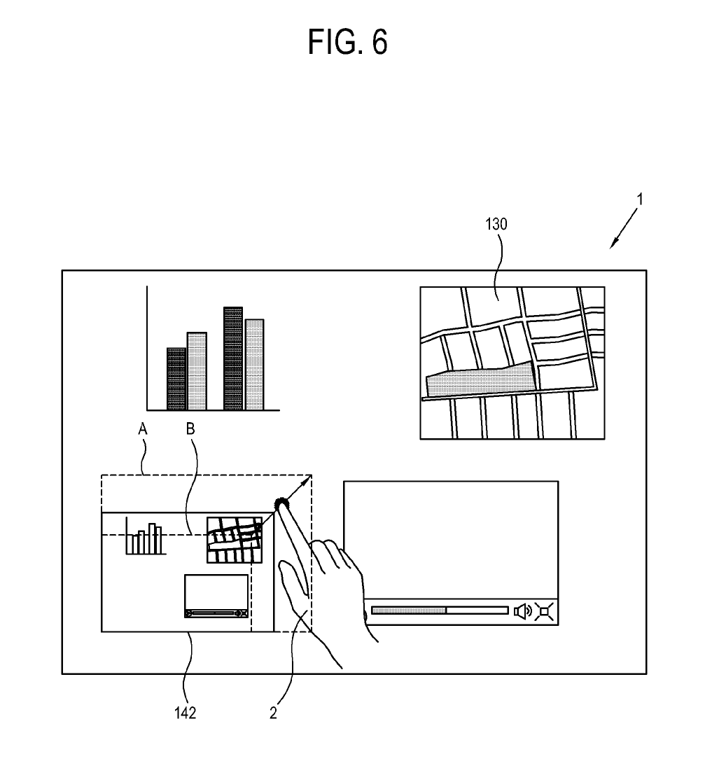

FIG. 6 illustrates an example in which the size of a UI is enlarged or reduced in a display apparatus according to an exemplary embodiment, which illustrates an example in which when the size of the generated UI is too small as shown in FIG. 5 or too large to be operated, the size of the UI is adjusted based on a touch input.

For example, in order to enlarge the UI 142, the user 2 may touch a specific position to move to a position A, so that the UI 142 is adjusted to be enlarged.

Similarly, in order to reduce the UI 142, the user 2 may touch a specific position to move to a position B, so that the UI 142 is adjusted to be reduced.

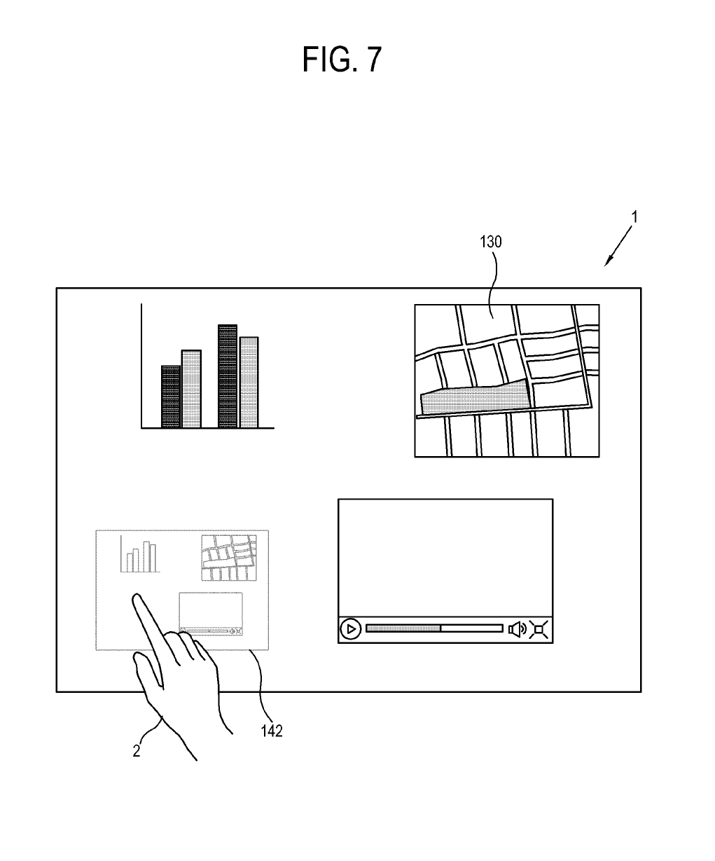

FIG. 7 illustrates an example in which the transparency of a UI is controlled (reduced) in a display apparatus according to an exemplary embodiment.

The generated UI 142 covers a part of the display section 130, and thus, may cause inconvenience to a viewer. Thus, by adjusting the transparency of the UI 142, it is possible to reduce inconvenience to the viewer. The transparency of the UI 142 may be controlled by adjusting transparency setting using a menu that is provided in the display apparatus 1, or may be controlled by a predetermined touch input. For example, if the user 2 presses a left side of the UI 142 with a long touch, an adjustment bar for transparency adjustment may appear. Then, the user may operate the adjustment bar to adjust the transparency of the UI 142 to be light or dark.

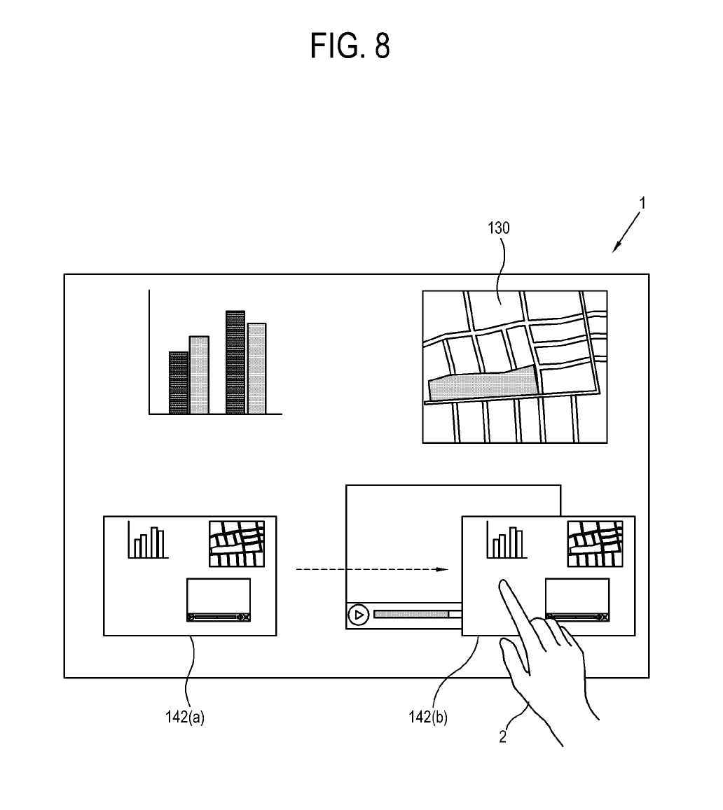

FIGS. 8 to 10 illustrate an example in which a UI is moved and generated in a display apparatus according to an exemplary embodiment.

The user 2 may give or provide an explanation to a viewer using a displayed image. In this case, the user 2 may move to the left or right side for explanation, or may move or delete the generated UI 142 for the convenience of object operation.

As an example, in a case where a UI 142(a) is generated on the left side of the display section 130 and the user 2 is located on the right side for or to conduct the explanation, the user 2 first moves to the left side to operate the UI 142(a). Then, when the user 2 moves from the left side to the right side, the user 2 may touch the UI 142(a) across the display to move the UI 142(a) to the right side in a continuous movement action after the second touch (dashed line with arrow representing the motion), as shown in FIG. 8.

As another example, in a case where the UI 142(a) is generated on the left side of the display section 130 and the user 2 moves from the left side to the right side for explanation, the user 2 may perform a predetermined touch input after movement. Then, as shown in FIG. 9, the UI 142(a) on the left side of the display section 130 disappears (dashed lines representing the disappearance), and a UI 142(b) which is the same as the UI 142(a) is generated at a predetermined touch input position on the right side of the display section 130.

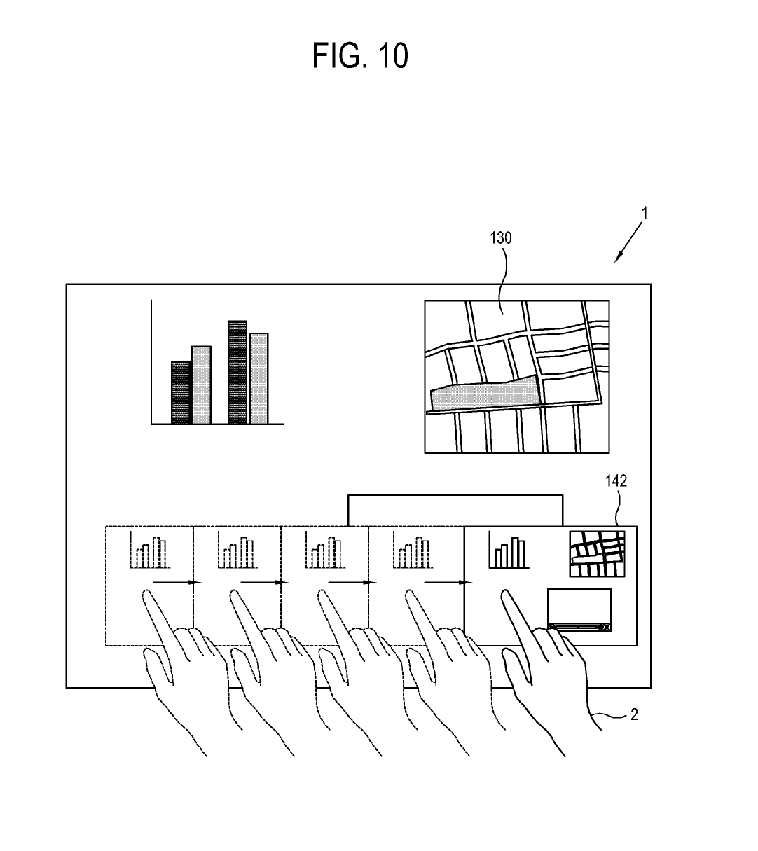

As still another example, as shown in FIG. 10, in a case where the user 2 moves from the left side of the display section 130 to the right side thereof, the user may touch the UI 142(a) on the left side of the display section 130 and then may act like throwing or flicking the UI 142(a) to the right side of the display section 130. In this case, the touch of the UI 142(a) moves from the left side to the right side, and then, stops. Then, the UI 142(a) may move to the right side according to a moving speed of the touch or according to a gradually decreased speed.

As yet another example the UI 142 may be dragged to a new position.

As yet still another example, the UI 142 may be rotated. For example, when the user 2 writes notes through the UI 142, writing with the UI 142 being disposed laterally may be convenient to the user 2. In this case, the UI 142 may be rotated by 90 degrees, for example.

The plurality of display apparatuses 1 may be combined to form an electronic whiteboard. For example, if four or nine display apparatuses 1 form a single screen or multi-screen, the UI 142 corresponding to a screen of the display apparatus 1 located at a position where the user 2 can operate the UI 142 may be generated to operate the single screen displayed in the plurality of display apparatuses 1. Further, the UI 142 may move between the plurality of display apparatuses 1, and thus, the user 2 may freely and conveniently operate the entire screen through the UI 142.

According to the above-described display apparatus 1, the UI 142 including a thumbnail image corresponding to an image displayed in the display section 130 is generated, and when a touch input of the user 2 is received at a first position of the thumbnail image of the generated UI 142, it is determined that the touch input is received at a corresponding second position of the image displayed in the display section 130. Thus, it is possible to operate the entire screen of the display section 130 of the display apparatus 1.

Although a few exemplary embodiments have been shown and described, it will be appreciated by those skilled in the art that changes may be made in these exemplary embodiments without departing from the principles and spirit of the embodiments, the scope of which is defined in the appended claims and their equivalents.

What is claimed is:

1. A display apparatus, comprising:
an image receiving section which receives an image;
an image processing section which processes the received image;
a display section which displays the processed image and comprises a touch panel through which a touch input of a user is receivable;
a UI (User Interface) generating section which generates a UI in the display section; and
a controller which performs a control for displaying the processed image and generating the UI comprising a thumbnail type image corresponding to the displayed image, and determines, if the touch input of the user is received at a first position of the thumbnail type image of the generated UI through the touch panel, whether the touch input is received at a corresponding second position of the image displayed in the display section to control the image processing section.

2. The display apparatus according to claim 1,
wherein the controller controls a size of the UI.

3. The display apparatus according to claim 1,
wherein the controller controls a transparency of the UI.

4. The display apparatus according to claim 1,
wherein the controller performs a control for at least one of generation and deletion of the UI in response to a predetermined touch input of the user.

5. The display apparatus according to claim 4,
wherein in a case where at least one UI is generated in the display section, if the predetermined touch input is received, the controller performs a control for moving at least one UI to a position corresponding to the predetermined touch input.

6. The display apparatus according to claim 4,
wherein in a case where a first UI is generated in the display section, if the predetermined touch input is received, the controller performs a control for deleting the first UI and generating a second UI at a position corresponding to the predetermined touch input.

7. The display apparatus according to claim 1,
wherein if the touch input of the user is received at a predetermined position of the thumbnail type image, the controller controls the image processing section to move the UI.

8. The display apparatus according to claim 7,
wherein if the touch input of the user is moved while being maintained, the controller performs a control for moving the UI corresponding to a position of the touch input.

9. The display apparatus according to claim 8,
wherein if the touch input of the user is finished, the controller performs a control for stopping movement of the UI.

10. The display apparatus according to claim 7,
wherein if the touch input of the user is finished during movement of the UI, the controller performs a control for moving the UI on the basis of a moving speed of the UI.

11. A control method of a display apparatus, comprising:
processing and displaying an image;
generating a UI (User Interface) comprising a thumbnail type image corresponding to the displayed image;
receiving a touch input of a user at a first position of the thumbnail type image of the generated UI; and
determining that the touch input is received at a corresponding second position of the displayed image.

12. The method according to claim 11,
wherein an action associated with receiving of the touch input comprises controlling a size of the UI.

13. The method according to claim 11,
wherein an action associated with receiving of the touch input comprises controlling a transparency of the UI.

14. The method according to claim 11,
wherein the generation of the UI comprises performing at least one of generation and deletion of the UI in response to a predetermined touch input of the user.

15. The method according to claim 14,
wherein the performance of at least one of the generation and deletion of the UI comprises:
receiving the predetermined touch input in a case where at least one UI is generated in the display section; and
moving the at least one UI to a position corresponding to the predetermined touch input.

16. The method according to claim 15,
wherein the movement of the UI to the position of the predetermined touch input comprises:
deleting, if the predetermined touch input is received in a case where a first UI is generated in the display section, the first UI; and
generating a second UI at a position corresponding to the predetermined touch input.

17. The method according to claim 11,
wherein the reception of the touch input of the user comprises moving, if the touch input of the user is received at a predetermined position of the thumbnail type image, the UI.

18. The method according to claim 17,
wherein the reception of the touch input of the user comprises moving, if the touch input of the user is moved while being maintained, the UI corresponding to a position of the touch input.

19. The method according to claim 18,
wherein movement of the UI comprises stopping, if the touch input of the user is finished, movement of the UI.

20. The method according to claim 17,
wherein movement of the UI comprises moving, if the touch input of the user is finished during movement of the UI, the UI on the basis of a moving speed of the UI.

21. A display apparatus, comprising:
a display which displays an image and comprises a touch screen via which a touch input of a user is detected; and
a processor receiving the image, generating a user interface (UI) on the display comprising a reduced size image of the entire image, determining, after the touch input of the user is detected at a first position of the thumbnail image of the generated UI via the touch panel, whether the touch input is detected at a second position of the image displayed on the display to control the image processing and performing an image operation when the touch input at the second position is detected.

22. A display apparatus as recited in claim 21, wherein the image operation determines one of a size of the UI, a transparency of the UI, whether the UI is deleted, a motion of the UI, a drag of the UI, a flick of the UI and generation of a second UI.
